(19) United States
(12) Patent Application Publication
(10) Pub. No.: US 2008/0071039 A1
(43) Pub. Date: Mar. 20, 2008

(54) Protective Material for Heat Sensitive Paper

(75) Inventors: Akinori Etoh, Chiba (JP); Tomokazu Ishizuka, Chiba (JP); Yukie Ogawa, Chiba (JP); Takashi Kojima, Kanagawa (JP)

Correspondence Address: BUCHANAN, INGERSOLL & ROONEY PC, POST OFFICE BOX 1404, ALEXANDRIA, VA, 22313-1404, US

(73) Assignee: Mitsui Chemicals Inc., Minato-ku ,Tokyo (JP)

(21) Appl. No.: 11/662,387

(22) PCT Filed: Sep. 7, 2005
(86) PCT No.: PCT/JP05/16390

§ 371 Date: Mar. 9, 2007

(30) Foreign Application Priority Data
Sep. 10, 2004 (JP) 2004-263398

(51) Int. Cl. C08G 18/62

(52) U.S. Cl. 525/451

(57) ABSTRACT

A protective material for a heat sensitive paper, which is an emulsion including water, a water soluble polymer (A), and a hydrophobic polymer (B), at least one of (A) and (B) containing a structural unit derived from a monomer (C) having a sulfonic acid group or a salt thereof. The protective material can provide a higher level of durability (e.g., water resistance, plasticizer resistance, alcohol resistance) against various materials, and can ensure good running stability, as compared with the conventional protective material.

### TECHNICAL FIELD

The present invention relates to a heat sensitive recording material. Specifically, the invention relates to a protective material for a heat sensitive paper which is a specific copolymer emulsion and which, by constituting an intermediate layer, a recording layer or a protective layer of the heat sensitive paper recording material, is capable of significantly improving the durability of the recording layer and the recorded image of the recording material.

### BACKGROUND ART

General recording materials are composed of a support and a colorless or lightly colored heat sensitive recording layer which contains an electron donating basic dye and an electron accepting organic or inorganic substance. Such recording materials, particularly heat sensitive recording paper, have been widely used as output sheets for a variety of printers including facsimiles, terminals for industrial instrumentation, terminals for medical care, handy terminals, POS systems and ticket vending systems. Thus, as the application of these heat sensitive recording materials is expanding, the environments in which they are used are also diversifying. However, there are the following prevalent problems in their ordinary use. Specifically, they have problems that the recording layer often comes off when the heat sensitive recording materials are brought into contact with water, and when the recording materials are brought into contact with a vinyl chloride film or sheet, the images fade or disappear due to the presence of various plasticizers contained in the vinyl chloride. Moreover, the images fade or disappear, or a color is developed when the heat sensitive recording materials are brought into contact with oils and fats or solvents. Therefore, as means for solving the above-mentioned problems, various investigations and attempts have been made in order to improve a binder or a color-developing material in the heat sensitive recording layer. However, none has satisfied all the water resistance, plasticizer resistance, oil/fat resistance, solvent resistance, and the like. Particularly, under the recent circumstances where more durability is required as the application of these heat sensitive recording materials is expanding, it has been difficult to solve the above-mentioned problems by improving the binder or the color-developing material in the heat sensitive recording layer alone.

As such, as means for solving these problems, various methods in which a protective layer is provided on a heat sensitive recording layer have been proposed. For example, there has been proposed an emulsion for heat sensitive recording material wherein a copolymerized resin (A) obtained by polymerization of (a) methacrylamide and (b) a vinyl monomer containing a carboxyl group is distributed on the surface of a resin particle (B) obtained by polymerization of (c) a vinyl monomer (Patent Document 1). By providing the protective layer on the recording layer, durability of the recording layer and of the recorded image is improved to some degree. However, when the resin components for the protective layer have a high solid content for the purpose of improving the production efficiency, etc., it is difficult to apply the resin due to its high viscosity. Thus, to solve the problem, the molecular weight of the water soluble polymer is lowered. However, when the water soluble polymer has a reduced molecular weight, the durability of the protective layer is lowered. Accordingly, the durability of the recording layer and of the recorded image is insufficient.

[Patent Document 1] JP-A No. 2001-270251

### DISCLOSURE OF THE INVENTION

### Problems to be Solved by the Invention

It is an object of the present invention to provide a protective material for a heat sensitive paper which gives a higher level of durability (e.g., water resistance, durability against a plasticizer (hereinafter, referred to as plasticizer resistance), alcohol resistance, etc.) against various materials, and which ensures good running stability, as compared with the conventional ones.

### Means to Solve the Problems

The present inventors have conducted extensive studies to solve the foregoing problems. As a result, they have found that an emulsion obtained by copolymerization of specific monomers can protect a heat sensitive paper with extremely excellent durability even at a high solid content, thus completing the present invention.

Specifically, the present invention relates to a protective material for a heat sensitive paper, which is an emulsion comprising water, a water soluble polymer (A), and a hydrophobic polymer (B), at least one of (A) and (B) containing a structural unit derived from a monomer (C) having a sulfonic acid group or a salt thereof.

### EFFECT OF THE INVENTION

According to the present invention, there can be provided a protective material for a heat sensitive paper which gives a higher level of durability (e.g., water resistance, plasticizer resistance, alcohol resistance, etc.) against various materials, and ensures good running stability, as compared with the conventional ones.

### PREFERRED EMBODIMENTS OF THE INVENTION

Hereinbelow, the present invention will be described in detail.

[Water Soluble Polymer (A)]

For the present invention, the water soluble polymer is a polymer which has a hydrophilic group in the polymer chain, and thus is soluble in water. To introduce the monomers (C) containing a sulfonic acid group or a salt thereof to the water soluble polymer, the monomers having a sulfonic acid group or a salt thereof may be graft polymerized to a natural polymer such as gelatin or starch. Alternatively, the monomers having a sulfonic acid group or a salt thereof may be graft polymerized to a semi-synthetic polymer such as carboxymethyl cellulose. Still alternatively, the monomers having a sulfonic acid group or a salt thereof may be copolymerized to a synthetic polymer such as polyvinyl alcohol. In particular, the synthetic polymer is preferable due to its high degree of freedom. Particularly preferably, the synthetic polymer has acrylamide or methacrylamide (hereinafter, referred to as (meth)acrylamide) as a main component, and is copolymerized with a vinyl monomer having a sulfonic acid group or a salt thereof.

Further, the copolymerization may involve monomers capable of giving water solubility to the polymer, such as acrylic acid, methacrylic acid, 2-hydroxyethylmethacrylate and vinyl pyrrolidone; and various vinyl compounds capable of giving hydrophobicity, such as styrene, acrylonitrile, methacrylic acid ester and acrylic acid ester. Among these, (meth)acrylamide is particularly preferable in terms of running stability (heat resistance), plasticizer resistance, or the like, and it has a weight average molecular weight, as measured by a GPC method, of 5,000 to 500,000.

[Hydrophobic Polymer (B)]

The hydrophobic polymer may be any one which is not soluble in water, and is used as dispersed in a solution of the water and the water soluble polymer. Most of the synthetic polymers are hydrophobic, and any such synthetic polymers may be used, with examples including polymers of vinyl monomers, polyesters and polyurethanes. In particular, a thermoplastic polymer which can be obtained as fine particles is preferable. Examples of the polymers include polymers of the above-mentioned monomers capable of giving hydrophobicity, polymers and copolymers of olefins such as ethylene, propylene and 1-butene, and copolymers of these olefins and dienes. In particular, polymers and copolymers of acrylonitrile, styrene, butyl acrylate, and 2-ethylhexyl acrylate are preferable. By copolymerization of the hydrophobicity-giving monomers and the monomers (C) having a sulfonic acid group or a salt thereof, the monomers (C) having a sulfonic acid group or a salt thereof can be introduced to the hydrophobic polymer. Further, the hydrophobic polymer may be copolymerized with monomers capable of giving water solubility to the polymers, such as acrylic acid, methacrylic acid, 2-hydroxyethylmethacrylate and vinyl pyrrolidone.

Among these monomers, polymers and copolymers of monomers selected from acrylonitriles are preferable in terms of water resistance. The weight average molecular weight of the polymers, as measured by a GPC method, is from 10,000 to 2,000,000.

The hydrophobic polymer may be prepared as dispersion in water separately from the water soluble polymer, and the dispersion may be mixed with the water soluble polymer. Alternatively, the monomer(s) for the hydrophobic polymer may be polymerized in a solution of the water soluble polymer to form a dispersion.

Herein, the weight ratio of the water soluble polymer (A) and the hydrophobic polymer (B) is 0-90 parts by weight to 10-100 parts by weight, and preferably 5-65 parts by weight to 35-95 parts by weight.

[Monomer (C) Having Sulfonic Acid Group or Salt Thereof]

In the present invention, at least one of the water soluble polymer (A) and the hydrophobic polymer (B) contains a structural unit derived from the monomer (C) having a sulfonic acid group or a salt thereof. Specifically, the monomer is a compound represented by the general formula (1), or a salt thereof. 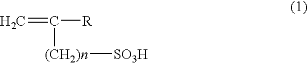
wherein R is a hydrogen atom or a lower alkyl group having 1 to 3 carbon atoms, and n is an integer of 1 to 8.

In the general formula (1), the lower alkyl group is preferably an alkyl group having 1 to 3 carbon atoms, specifically a methyl group, an ethyl group, an n-propyl group, or an i-propyl group. The salt thereof is, for example, a salt of an alkali metal such as sodium or potassium, an ammonium salt, or the like. Specific examples of the sulfonated compound represented by the general formula (1) may include, for example, allylsulfonic acid, sodium allylsulfonate, methallylsulfonic acid, sodium methallylsulfonate, and ammonium methallylsulfonate. Among these, sodium methallylsulfonate is preferable from the viewpoint that the protective layer for heat sensitive recording paper maintains the performances even with a high resin solid content in the emulsion. The amount of these compounds is such that the component (C) is contained in a proportion of 0.05 to 20 parts by weight, and preferably 0.3 to 10 parts by weight, based on 100 parts by weight of the total of the water soluble polymer (A), the hydrophobic polymer (B), and the monomer (C) having a sulfonic acid group or a salt thereof, from the viewpoint of the alcohol resistance.

[Emulsion]

The emulsion of the present invention is an emulsion in which water is contained in a proportion of 50 to 90 parts by weight, and preferably 50 to 85 parts by weight, based on 100 parts by weight of the total of the water soluble polymer (A) and the hydrophobic polymer (B), and the weight ratio of (A) to (B) is 0-90 parts by weight to 10-100 parts by weight. To determine these weight ratios, the solids of the emulsion and the emulsion are centrifuged in a supercentrifuge (himacCS100FX; manufactured by HITACHI) at 85000 rpm, at 20° C. for 1 hour. The weight of the solids in the supernatant is obtained as the weight of the water soluble polymer. The weight of the hydrophobic polymer is obtained by subtraction of the weight of the water soluble polymer from the content of the solids before centrifugation. With the amount of water within the above-described range, the balance between the solid concentration and the viscosity is good, leading to easy application and excellent physical properties of the film after drying.

The particle diameter and the viscosity of the emulsion are not particularly limited, but the particle diameter is preferably 50 to 800 nm, as measured by a DLS method, and the viscosity is preferably 5 to 10000 mPa·s as measured using a BM type viscometer (rotor Nos. 1 to 4, rotation: 60, temperature: 25° C.) at a solid concentration of 20%. Further, the hydrophobic polymer preferably has a glass transition temperature of −30 to 110° C. The glass transition temperature is a glass transition temperature of the copolymer, and is determined according to the Fox's equation (Bull. Am. Phys. Soc., Vol. 1, No. 3, p. 123 (1956)).

[Process for Preparation of Emulsion]

In the present invention, the process for synthesizing the emulsion is not particularly limited, but radical polymerization which is carried out in a solvent comprising water as a main component is preferable. Examples of the process for synthesizing the emulsion include, but are not limited to, a process simultaneously synthesizing the water soluble polymer (A) and the hydrophobic polymer (B); a process comprising separately polymerizing the water soluble polymer and the hydrophobic polymer, and then mixing them; a process comprising firstly synthesizing the water soluble polymer, and then synthesizing the hydrophobic polymer in the presence of the water soluble polymer; and a process comprising firstly synthesizing the hydrophobic polymer, and then synthesizing the water soluble polymer in the presence of the hydrophobic polymer. The monomer (C) having a sulfonic acid group or a salt thereof is contained in at least one of the water soluble polymer and the hydrophobic polymer. In the present invention, a surfactant or a water soluble polymer can be appropriately employed for the purpose of improving the polymerization stability, and the storage stability of the emulsion. Examples of the surfactant include anionic surfactants, cationic surfactants, and nonionic surfactants.

Examples of the water soluble polymer include polyvinyl alcohol and polyethylene glycol. The polymerization initiator in synthesis of the polymer is not limited, but water soluble radical initiators are preferable, and persulfates such as ammonium persulfate, and water soluble azo initiators such as 4,4′-azobis(4-cyanovaleric acid) are particularly preferable. The polymerization temperature in synthesis of the polymer is not limited, but it is preferable to synthesize the polymer in the temperature range of 30 to 95° C. in consideration of the preparation time or the conversion ratio (reaction ratio) of the monomers to the copolymer, with the temperature being particularly preferably 50 to 85° C. Further, a pH adjusting agent, or EDTA or a salt thereof as a metal ion chelator can be employed for improving the preparation stability in polymerization. After preparation of the emulsion, the pH may be adjusted. Examples of neutralizing agents include, but not limited thereto, (aqueous) ammonia, sodium hydroxide, potassium hydroxide and various amines. Aqueous ammonia is preferably used because it reduces damage to the heating head in the heating step. The pH is not limited, but it is preferably 7 to 10 from the viewpoint of the storage property, the mechanical stability, and the like of the copolymer emulsion.

The monomers which are used in the synthesis of the polymer are not particularly limited. Examples of the vinyl monomers include functional group-containing vinyl monomers, such as: aromatic vinyl monomers such as styrene, and α-methyl styrene; alkyl (meth)acrylates such as methyl methacrylate; cyano group-containing vinyl monomers such as (meth)acrylonitrile; amide group-containing vinyl monomers such as (meth) acrylamide; carboxyl group-containing vinyl monomers such as (meth) acrylic acid; hydroxyl group-containing vinyl monomers such as 2-hydroxyethyl (meth)acrylate; glycidyl group-containing vinyl monomers such as glycidyl (meth)acrylate; amino group-containing vinyl monomers such as N,N-dimethylaminoethyl (meth)acrylate; and acetoacetoxy group-containing vinyl monomers such as acetoacetoxyethyl (meth)acrylate. If necessary, a crosslinkable vinyl monomer may be used, and examples of the monomer include methylenebis (meth)acrylamide, divinyl benzene, and polyethylene glycol chain-containing di(meth)acrylate. The crosslinkable vinyl monomer may contain two or more vinyl groups. For the purpose of adjusting the molecular weight, a molecular weight modifier such as n-dodecyl mercaptan, 1-thioglycerol or an α-methylstyrene dimer may also be used.

[Protective Material for Heat Sensitive Paper]

The protective material for a heat sensitive paper of the present invention is the above-described emulsion. Further, various additives may be added. The additives may be added before, during or after polymerization of the above-described monomers. Examples of the additives include a pH regulator, a chelating agent, a pigment, a wetting agent, an antistatic agent, an antioxidant, a preservative, a UV absorber, a light stabilizer, a fluorescent brightener, a colorant, a penetrating agent, a foaming agent, a releasing agent, an anti-foaming agent, a defoaming agent, a flow modifier, and a thickening agent, but are not limited thereto.

Further, in the present invention, a filler may be blended, if desired. The amount thereof to be added is not particularly limited, and the kind and the amount of the filler can be appropriately selected within the range which does not adversely affect the object of the present invention. Examples of the filler include inorganic fillers such as calcium carbonate, magnesium carbonate, kaolin, clay, and colloidal silica; and organic fine particles such as polystyrene fine particles. Examples of the optional components other than the fillers include water resistant additives (crosslinking agents), and lubricants such as metal salts of higher fatty acids, higher fatty acid amides and low-molecular weight polyolefin fine particles for improving running properties (heat resistance, anti-sticking property, running stability). Among these, the water resistant additives (crosslinking agents) are preferable because they increase the toughness of the protective layer, and thus improve the durability of the heat sensitive layer and the recorded image, while enhancing the suitability with the heating head (stickiness, and running stability). Examples of the crosslinking agents include glyoxal, dimethylol urea, glycidyl ethers of polyhydric alcohols, ketene dimer, dialdehyde starch, polyamideamine-epichlorohydrin modified product, ammonium zirconium carbonate, aluminum sulfate, and calcium chloride.

Further, if necessary, other well-known aqueous resins may be used in combination with the above-described components. Examples of the resins include natural resins (for example, sodium alginate, starch, casein, celluloses) and synthetic resins. Among these, modified products of polyvinyl alcohol are preferred and examples thereof include carboxyl-modified polyvinyl alcohol, acetoacetyl-modified polyvinyl alcohol, epoxy-modified polyvinyl alcohol, silanol-modified polyvinyl alcohol, amino-modified polyvinyl alcohol, olefin-modified polyvinyl alcohol, amide-modified polyvinyl alcohol, and nitrile-modified polyvinyl alcohol, but are not limited to these. A region on which the protective material for a heat sensitive paper of the present invention is applied, is not limited to the surface of the heat sensitive recording layer and the back of the support, and the protective material for a heat sensitive paper can be appropriately applied onto a part in which the protective layer will show higher function. In addition, the coloring system of the heat sensitive recording layer according to the present invention is not particularly limited. Examples of the coloring system include a system comprising a leuco dye and an acidic substance represented by a phenolic substance; a system comprising an imino compound and an isocyanate compound; and a system comprising a diazo compound and a coupler.

The protective layer of the present invention is applied on a known heat sensitive recording layer normally provided on a paper, a synthetic paper, a film, etc. as a support and/or is applied on the back of the support, or between the support and the heat sensitive recording layer, in an amount of 1 to 10 g/m² in terms of dry weight, using an air knife coater, a gravure coater, a roll coater, or the like, thereby achieving the object of the present invention. In the case where the protective layer should have higher gloss and specular gloss, the surface of the protective layer may be cast treated as required. Alternatively, the coating solution for the protective layer may be applied on a specular metal drum, a flat PET film, or the like and dried, and then the coating layer may be pressed against and transferred to the heat sensitive recording layer.

### EXAMPLES

The present invention will be further described in detail with reference to Examples, but the present invention is not limited to these Examples. The terms “parts” and “%” in these Examples indicate “parts by weight” and “% by weight”, respectively unless otherwise specified.

### Example 1

### Method for Simultaneously Synthesizing Water Soluble Polymer and Hydrophobic Polymer

Into a separable flask equipped with a stirrer and a reflux condenser were put 150.0 parts of distilled water and 0.3 part of sodium dodecylsulfonate, the flask was purged with nitrogen gas and then the temperature of the flask was raised to 80° C. Thereafter, 2.0 parts of ammonium persulfate was put into the flask. Then, an emulsion obtained by emulsifying the monomers having the following composition in 0.7 part of sodium dodecylsulfate and 54.4 parts of distilled water was continuously added into the flask over about 4 hours, and the mixture was aged at 80° C. for 2 hours to complete the polymerization. After completion of the polymerization, the mixture was cooled to room temperature, neutralized by adding aqueous ammonia, and adjusted to pH 8.0 approximately. Consequently, an emulsion having a solid content of 40.5% was obtained.

### Composition of Monomers

| | |
|---|---|
| Methacryl amide | 35.0 parts |
| Sodium methallylsulfonate | 0.5 parts |
| Methacrylic acid | 10.0 parts |
| 2-Hydroxyethyl methacrylate | 20.0 parts |
| Acrylonitrile | 30.0 parts |
| n-Butyl acrylate | 40.0 parts |
| n-Dodecyl mercaptan | 0.5 parts |

The weight ratio of the water soluble polymer to the hydrophobic polymer was 7.3 to 92.7. 30 Parts of water was added to 100 parts of the thus-obtained emulsion. Then, to the diluted emulsion were added 10 parts of a 20% zinc stearate dispersion (F-115 ultrafine particle type, manufactured by Chukyo Yushi. Co., Ltd.) and 4.8 parts of a 42% polyolefin emulsion (Chemipearl W4005, manufactured by Mitsui Chemicals, Inc.). The mixture was uniformly mixed and then was applied onto the surface of a commercially available heat sensitive paper for word processor having no surface treatment in an amount of 3 g/m² in terms of dry weight using a bar coater, and the coating was dried (forcibly dried at 60° C. for 30 seconds and cured under 20° C./60% RH atmosphere for 7 days). Consequently, a heat sensitive recording material was obtained. The results of evaluation of the heat sensitive recording paper are shown in Table 2.

### Example 2

### Method for Firstly Synthesizing Water Soluble Polymer and then Synthesizing Hydrophobic Polymer in the Presence of Water Soluble Polymer

Into a separable flask equipped with a stirrer and a reflux condenser was put 80 parts by weight of distilled water, the flask was purged with nitrogen gas and then the temperature of the flask was raised to 80° C. Thereafter, 2.0 parts of ammonium persulfate was put into the flask. Then, a mixture of the monomers having the following composition and 150 parts of water was continuously added into the flask over 2 hours under stirring. The mixture was aged at that temperature for 2 hours to complete the polymerization. Thus, an aqueous water soluble polymer solution (A1) having a solid content of 30.7% was obtained.

### Composition of Monomers for Water Soluble Polymer

| | |
|---|---|
| Methacryl amide | 55.0 parts |
| Sodium methallylsulfonate | 5.0 parts |
| Methacrylic acid | 10.0 parts |
| 2-Hydroxyethyl methacrylate | 20.0 parts |
| Acrylonitrile | 10.0 parts |

To 260 parts of the obtained aqueous water soluble polymer solution (A1) was put 45 parts of distilled water, and the flask was purged with nitrogen gas and then the temperature of the flask was raised to 75° C. Thereafter, 1.0 part of ammonium persulfate was put into the flask. Then, a vinyl monomer emulsion having the following composition was continuously added into the flask over 3 hours, and the mixture was held for 3 hours to complete the polymerization. Thereafter, the mixture was cooled to not more than 40° C., and then adjusted to pH 8.0 with aqueous ammonia. Consequently, a milky white copolymer emulsion having a solid content of 40.6% was obtained. The obtained copolymer emulsion contained 18.0% of the water soluble polymer, and 22.6% of the hydrophobic polymer.

### Vinyl Monomer Emulsion

| | |
|---|---|
| Acrylonitrile | 55.0 parts |
| n-Butyl acrylate | 45.0 parts |
| Sodium dodecylsulfate | 0.1 parts |
| Distilled water | 40.0 parts |

A heat sensitive recording material was obtained in the same manner as in Example 1 except that the above-obtained emulsion (corresponding to Preparation Example 1 in Table 1) was used, and that 15.4 parts of 13% aqueous zirconium ammonium carbonate solution (DAIICHI KIGENSO KAGAKU KOGYO CO., LTD.: Zircosol AC-7) as a crosslinking agent was added to the emulsion. Further, the heat sensitive recording paper prepared was evaluated, and it exhibited good performances as shown in Table 2.

### Example 3

A heat sensitive recording material was obtained in the same manner as in Example 1 except that an emulsion obtained in Preparation Example 2 in Table 1 was used, and that 6.7 parts of 30% polyamideamine/epichlorohydrin modified product (manufactured by Mitsui Chemicals, Inc.: Uramine P-5600) as a crosslinking agent, and 12 parts of a preliminarily prepared 50% fine particle silica slurry (manufactured by Mizusawa Industrial Chemicals, Ltd.: MIZUKASIL P-527) as a filler were added to the emulsion.

### Example 4

A heat sensitive recording material was obtained in the same manner as in Example 1 except that an emulsion obtained in Preparation Example 3 in Table 1 was used, and that 6.7 parts of 30% polyamideamine/epichlorohydrin modified product (manufactured by Mitsui Chemicals, Inc.: Uramine P-5600) as a crosslinking agent was added to the emulsion.

### Example 5

A heat sensitive recording material was obtained in the same manner as in Example 1 except that an emulsion obtained in Preparation Example 4 in Table 1 was used, that that 6.7 parts of 30% polyamideamine/epichlorohydrin modified product (manufactured by Mitsui Chemicals, Inc.: Uramine P-5600) as a crosslinking agent was added to the emulsion.

### Example 6

To 160 parts of an emulsion obtained in Preparation Example 5 in Table 1 was added 6.7 parts of 30% polyamideamine/epichlorohydrin modified product (manufactured by Mitsui Chemicals, Inc.: Uramine P-5600) as a crosslinking agent. The mixture was uniformly mixed and then was applied onto the surface of a commercially available heat sensitive paper for word processor having no surface treatment in an amount of 3 g/m² in terms of dry weight using a bar coater, and the coating was dried (forcibly dried at 60° C. for 30 seconds and cured under 20° C./60% RH atmosphere for 7 days). Consequently, a heat sensitive recording material was obtained.

### Example 7

A heat sensitive recording material was obtained in the same manner as in Example 1 except that an emulsion obtained in Preparation Example 6 in Table 1 was used, and that 2 parts of glycidyl ether of polyhydric alcohol (manufactured by NAGASE CO., LTD.: Denacol EX-512) as a crosslinking agent was added to the emulsion.

### Comparative Example 1

### Method for Simultaneously Synthesizing Water Soluble Polymer and Hydrophobic Polymer

Into a separable flask equipped with a stirrer and a reflux condenser were put 150.0 parts of distilled water and 0.3 part of sodium dodecylsulfonate, the flask was purged with nitrogen gas and then the temperature of the flask was raised to 80° C. Thereafter, 2.0 parts of ammonium persulfate was put into the flask. Then, an emulsion obtained by emulsifying the monomers having the following composition in 0.7 part of sodium dodecylsulfate and 50.0 parts of distilled water was continuously added into the flask over about 4 hours. The mixture was aged at 80° C. for 2 hours to complete the polymerization. After completion of the polymerization, the mixture was cooled to room temperature, neutralized by adding aqueous ammonia, and adjusted to about pH 8.0. Consequently, an emulsion having a solid content of 40.0% was obtained.

### Composition of Monomers

| | |
|---|---|
| Methacryl amide | 30.0 parts |
| Methacrylic acid | 10.0 parts |
| 2-Hydroxyethyl methacrylate | 10.0 parts |
| Styrene | 40.0 parts |
| 2-Ethyl hexyl acrylate | 40.0 parts |
| n-Dodecyl mercaptan | 0.5 parts |

The weight ratio of the water soluble polymer to the hydrophobic polymer was 6.8 to 93.2. 30 Parts of water was added to 100 parts of the thus-obtained emulsion. Then, to the diluted emulsion were added 10 parts of a 20% zinc stearate dispersion (F-115 ultrafine particle type, manufactured by Chukyo Yushi. Co., Ltd.) and 4.8 parts of a 42% polyolefin emulsion (Chemipearl W4005, manufactured by Mitsui Chemicals, Inc.). The mixture was uniformly mixed and then was applied onto the surface of a commercially available heat sensitive paper for word processor having no surface treatment in an amount of 3 g/m² in terms of dry weight using a bar coater, and the coating was dried (forcibly dried at 60° C. for 30 seconds and cured under 20° C./60% RH atmosphere for 7 days). Consequently, a heat sensitive recording material was obtained. The results of evaluation of the heat sensitive recording paper are shown in Table 2.

### Comparative Example 2

### Method for Firstly Synthesizing Water Soluble Polymer and then Synthesizing Hydrophobic Polymer in the Presence of Water Soluble Polymer

Into a separable flask equipped with a stirrer and a reflux condenser was put 80 parts by weight of distilled water, the flask was purged with nitrogen gas and then the temperature of the flask was raised to 80° C. Thereafter, 2.0 parts of ammonium persulfate was put into the flask. Then, a mixture of the monomers having the following composition and 150 parts of water was continuously added into the flask over 2 hours under stirring, and the mixture was aged at that temperature for 2 hours to complete the polymerization. Thus, an aqueous water soluble polymer solution having a solid content of 30.7% was obtained. This solution was clear and uniform.

### Composition of Monomers for Water Soluble Polymer

| | |
|---|---|
| Methacryl amide | 75.0 parts |
| Methacrylic acid | 7.0 parts |
| 2-Hydroxyethyl methacrylate | 13.0 parts |
| Acrylonitrile | 5.0 parts |

To 260.5 parts of the obtained aqueous water soluble polymer solution was put 45 parts of distilled water, and the flask was purged with nitrogen gas and then the temperature of the flask was raised to 75° C. Thereafter, 1.0 part of 4,4′-azobis(4-cyanovaleric acid) was put into the flask. Then, a vinyl monomer emulsion having the following composition was continuously added into the flask over 3 hours, and the mixture was held for 3 hours to complete the polymerization. Thereafter, the mixture was cooled to not more than 40° C., and adjusted to pH 8.0 with aqueous ammonia to obtain a milky white copolymer emulsion having a solid content of 40.6%. The obtained copolymer emulsion contained 18.0% of the water soluble polymer, and 22.6% of the hydrophobic polymer.

### Vinyl Monomer Emulsion

| | |
|---|---|
| Acrylonitrile | 55.0 parts |
| n-Butyl acrylate | 45.0 parts |
| Sodium dodecylsulfate | 0.1 parts |
| Distilled water | 40.0 parts |

A heat sensitive recording material was obtained in the same manner as in Example 1 except that 100 parts of the above-obtained emulsion was diluted by addition of 30 parts of water, and that 6.7 parts of 30% polyamideamine/epichlorohydrin modified product (manufactured by Mitsui Chemicals, Inc.: Uramine P-5600) as a crosslinking agent was added to the diluted emulsion. The results of evaluation of the heat sensitive recording paper are shown in Table 2.

[Methods of Evaluation]

(1) Running Stability

Solid black pattern image was printed under the following conditions using a thermal printer (available from Ohkura Electric Co., Ltd.: TH-PMD). The level of noise (crackling sound) and head contamination were comprehensively evaluated.

Voltage applied: 24 V

Pulse width: 1.74 ms

Energy applied: 0.34 mj/dot

◯: No noise was produced, no head contamination was observed, and paper ran smoothly.

X: Big crackling sound was generated, head contamination was observed, and paper did not run smoothly.

(2) Color Density

Image was formed under the above-described conditions, and the density of the image portion was measured with a Macbeth densitometer (RD-918; manufactured by Gretag Macbeth Co.).

(3) Water Resistance

A hot block of 140° C. was pressed against the heat sensitive recording surface for 1 second to produce a color. The recording material was immersed in water at room temperature for 24 hours such that the printed surface was completely under water. The density of the colored part was measured with a Macbeth densitometer.

(4) Plasticizer Resistance

A hot block of 140° C. was pressed against the heat sensitive recording surface for 1 second to produce a color. A transparent polyvinyl chloride adhesive tape for electric insulation (manufactured by Nitto Denko Corporation) was attached to the heat sensitive recording surface. The unit was allowed to stand at 40° C. for 24 hours, and then the tape was peeled off. The density before the tape was attached and after the tape was peeled off was measured with a Macbeth densitometer.

(5) Alcohol resistance

A 20% aqueous isopropanol solution was applied to an uncolored part, and the color development degree was observed with the naked eyes.

◯: No color was developed. (The protective layer showed good barrier properties against the alcohol.)

Δ: A color was developed as dots.

X: A color was developed on the front surface. (The protective layer showed poor barrier properties against the alcohol.)

TABLE 1
Preparation Examples 1-6

| Preparation Example | | | | | |
|---|---|---|---|---|---|
| 1 | 2 | 3 | 4 | 5 | 6 |

Synthesis of water soluble polymer

| Water soluble polymer (A) | | A1 | A2 | A3 | A4 | A5 | A6 |
|---|---|---|---|---|---|---|---|
| Input water | | 80 | 50 | 50 | 80 | 100 | 80 |
| Kind of polymerization initiator | | APS | KPS | KPS | ACVA | ACVA | APS |
| Amount of polymerization initiator | | 2 | 2 | 2 | 2 | 0.8 | 2 |
| Monomers | Methacrylamide | 55 | 90 | 93 | 85 | 85 | 85 |
| for water | Sodium | 5 | 5 | 7 | 1 | 1 | 3 |
| soluble | methallylsulfonate | | | | | | |
| polymer | Methacrylic acid | 10 | 4.5 | | 9 | 9 | |
| | 2-Hydroxyethyl | 20 | | | | | 7 |
| | methacrylate | | | | | | |
| | Methylene bisacrylamide | | 0.5 | | | | |
| | Acrylonitrile | 10 | | | | | 5 |
| | n-Butyl acrylate | | | | | | |
| | Styrene | | | | 5 | 5 | |
| | 2-Ethylhexyl acrylate | | | | | | |

| | | | | | | |
|---|---|---|---|---|---|---|
| Solid content of water soluble | 30.7 | 33.8 | 33.8 | 30.1 | 20.1 | 30.7 |
| polymer (W) (%) | | | | | | |

Synthesis of emulsion

| Amount of water soluble polymer (A) | | 260 | 520 | 350 | 165 | 395 | 310 |
|---|---|---|---|---|---|---|---|
| used (parts) | | | | | | | |
| Input water | | 45 | 30 | 40 | 70 | 187 | 45 |
| Kind of polymerization initiator | | APS | APS | APS | ACVA | ACVA | ACVA |
| Amount of polymerization initiator | | 1 | 1 | 1 | 1 | 1 | 1 |
| Vinyl | Acrylonitrile | 55 | | 10 | 60 | 60 | 50 |
| monomers | Styrene | | 50 | 40 | 4 | 4 | 10 |
| | n-Butyl acrylate | 45 | 27 | 40 | 30 | 30 | 10 |
| | 2-Ethylhexyl acrylate | | 20 | | | | 25 |
| | Divinylbenzene | | | | 1 | 1 | |
| | Methacrylic acid | | 3 | | | | 2 |
| | 2-Hydroxyethyl acrylate | | | 10 | 5 | 5 | 3 |

| | | | | | | |
|---|---|---|---|---|---|---|
| n-Dodecyl mercaptan | | | | 0.05 | 0.05 | |
| Sodium dodecylsulfate | 0.1 | 0.1 | 0.1 | 0.1 | 0.1 | 0.1 |
| Distilled water for emulsion | 40 | 40 | 40 | 40 | 40 | 40 |
| Solid content in emulsion (%) | 40.6 | 40.0 | 41.3 | 40.4 | 25.0 | 39.6 |
| Proportion of water soluble polymer | 44.4 | 63.7 | 54.1 | 33.6 | 44.3 | 48.8 |
| (A) (%) | | | | | | |
| Proportion of hydrophobic polymer | 55.6 | 36.3 | 45.9 | 66.4 | 55.7 | 51.2 |
| (B) (%) | | | | | | |

SDS: Sodium dodecylsulfate
APS: Ammonium persulfate
KPS: Potassium persulfate
ACVA: 4,4′-Azobis(4-cyanovaleric acid)

TABLE 2
Results of evaluation of heat sensitive recording material

| | | | | | | | | Comp. | Comp. |
|---|---|---|---|---|---|---|---|---|---|
| | Ex. 1 | Ex. 2 | Ex. 3 | Ex. 4 | Ex. 5 | Ex. 6 | Ex. 7 | Ex. 1 | Ex. 2 |
| Preparation | | Prep. | Prep. | Prep. | Prep. | Prep. | Prep. | | |
| Example | | Ex. 1 | Ex. 2 | Ex. 3 | Ex. 4 | Ex. 5 | Ex. 6 | | |
| Solid content in emulsion (%) | 30.7 | 29.3 | 32.3 | 32.3 | 31.0 | 25.2 | 31.3 | 30.4 | 31.1 |
| Running stability | ◯ | ◯ | ◯ | ◯ | ◯ | ◯ | ◯ | X | ◯ |
| Color density | 1.63 | 1.53 | 1.73 | 1.60 | 1.62 | 1.58 | 1.65 | 1.42 | 1.53 |
| Water resistance | 1.22 | 1.23 | 1.09 | 1.23 | 1.3 | 1.20 | 1.15 | 1.08 | 1.17 |
| Plasticizer resistance | 1.05 | 1.47 | 1.62 | 1.15 | 1.03 | 1.54 | 1.59 | 1.02 | 0.95 |
| Alcohol resistance | ◯ | ◯ | ◯ | ◯ | ◯ | ◯ | ◯ | Δ | X |

1. A protective material for a heat sensitive paper, which is an emulsion comprising water, a water soluble polymer (A), and a hydrophobic polymer (B), at least one of (A) and (B) containing a structural unit derived from a monomer (C) having a sulfonic acid group or a salt thereof.

2. The protective material for a heat sensitive paper according to claim 1, wherein the monomer (C) having a sulfonic acid group or a salt thereof is a compound represented by the following general formula (1) or a salt thereof: 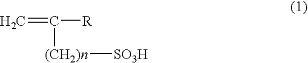
wherein R is a hydrogen atom or a lower alkyl group having 1 to 3 carbon atoms, and n is an integer of 1 to 8.

3. The protective material for a heat sensitive paper according to claim 1, wherein the weight ratio of the water soluble polymer (A) to the hydrophobic polymer (B) is 0-90 parts by weight to 10-100 parts by weight, and water is contained in a proportion of 50 to 90 parts by weight, based on 100 parts by weight of the total amount of (A) and (B).

4. The protective material for a heat sensitive paper according to claim 1, wherein the monomer (C) is contained in a proportion of 0.05 to 20 parts by weight, based on 100 parts by weight of the total amount of the water soluble polymer (A), the hydrophobic polymer (B), and the monomer (C) having a sulfonic acid group or a salt thereof.

5. The protective material for a heat sensitive paper according to claim 1, wherein the water soluble polymer (A) is a polymer or copolymer containing at least (meth) acrylamide, and has a weight average molecular weight of 5,000 to 500,000, and the hydrophobic polymer (B) is a copolymer containing at least acrylonitrile and has a weight average molecular weight of 10,000 to 2,000,000.
